(19) United States
(12) Patent Application Publication
(10) Pub. No.: US 2023/0236812 A1
(43) Pub. Date: Jul. 27, 2023

(54) USING SUSTAINABILITY TO RECOMPILE AND OPTIMIZE INTERRUPTED LANGUAGES AND BYTE-LEVEL EXECUTION IN MEETING SUSTAINABILITY GOALS

(71) Applicant: Dell Products L.P., Round Rock, TX (US)

(72) Inventors: Nicole Reineke, Northborough, MA (US); Eloy Francisco Macha, Las Cruces, NM (US); Robert A. Lincourt, Franklin, MA (US); David Frattura, Stamford, CT (US)

(21) Appl. No.: 17/648,561

(22) Filed: Jan. 21, 2022

(51) Int. Cl. G06F 8/41; G06F 8/60; G06F 11/36; G06F 11/30; G06F 9/50

(52) U.S. Cl. CPC G06F 8/443; G06F 8/60; G06F 11/3612; G06F 11/3051; G06F 9/505

(57) ABSTRACT

Recompiling code based on sustainability. Code is recompiled in a manner that accounts for sustainability values. When a deployment request is received, sustainability values are identified. The resources needed to fulfill the deployment request are identified based on the sustainability values and available resources. Once the resources that are likely to best meet the sustainability values are identified, the code is recompiled accordingly.

### FIELD OF THE INVENTION

Embodiments of the present invention generally relate to sustainability in code compilation and execution. More particularly, at least some embodiments of the invention relate to systems, hardware, software, computer-readable media, and methods for dynamically recompiling code with sustainability goals and policies.

### BACKGROUND

Sustainability may be defined as the ability to meet present needs without compromising the ability to meet future needs. Sustainability has many elements including environmental components, social components, and economic components. When the individual goals of values of sustainability are considered, it is evident that some sustainability goals may contradict or compete with other sustainability goals. This is not unexpected because the components of sustainability consider a wide range of policies.

Social sustainability goals, for example, may relate to education, community, equal opportunity, and opportunity. Environmental sustainability goals may relate to natural resource use and pollution prevention. Economic sustainability goals may relate to profits, cost savings, and research and development. Many of these goals can be applied to compute environments.

For example, in the context of computing, many users have heterogenous compute environments at their disposal. These compute environments may include core data centers, edge computing environment, and public clouds. Further, many users have an existing set of binaries, encapsulated code from interruptible languages, portable byte-code refactored binaries, or other executables.

When users are implementing sustainability goals, such as energy efficiency, carbon footprint awareness, the user's existing code may not be aligned with or adequately satisfy the user's sustainability goals. For example, different types of code may not consume the same amount of energy or be associated with the same amount of carbon generation when executed with respect to different computational environments.

For example, a user may not know if their binaries include or use sustainable-centric code-snippets, functions, libraries, and the like and may not have access to the code of these binaries. The user may have encapsulated code from interpreted languages (i.e., Java, Python, etc.) that run atop of a given runtime environment (JVM, Python, etc.), and may not have access to the entire code set of the encapsulated code or may not have the expertise to properly run a sustainability specific code audit against this type of code. The user may have byte-code refactored binaries encapsulated in a runtime environment (WASM, GraalVM, etc.), and may not have access to the code of these refactored binaries. The user's sustainability goals may be different for different computational sites.

More generally, a user may not be aware of or able to identify, for a given runtime and/or binary, the type of specific algorithm libraries and functions that will be used for processing. Further, the execution of a runtime or binary may result in different sustainability related outcomes because of the operating system, the instruction set architecture, or other factors. In fact, it is not currently possible to identify or improve a given set of runtimes or binaries to use best-fit sustainability resources.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1A discloses aspects of a sustainability engine that may be integrated into or used by a pipeline when recompiling code;

FIG. 1B discloses aspects of sustainability in computing development, deployment, and execution;

FIG. 1C discloses aspects of recompiling code using sustainability values;

FIG. 2 discloses aspects of a method for establishing compilation methods aligned with sustainability values and using the compilation methods to recompile code such that the recompiled code aligns with the sustainability values;

FIG. 3 discloses aspects of sustainability in compilation/recompilation methods;

FIG. 4 discloses aspects of recompiling and deploying code in a manner that considers sustainability values;

FIG. 5 discloses aspects of recompilation methods; and

FIG. 6 discloses aspects of a computing device or a computing system.

### DETAILED DESCRIPTION OF SOME EXAMPLE EMBODIMENTS

Embodiments of the present invention generally relate to sustainability and sustainable-supporting code. More particularly, at least some embodiments of the invention relate to systems, hardware, software, computer-readable media, and methods for dynamically recompiling or refactoring code or binaries to align with sustainability goals and practices. More specifically, embodiments of the invention allow existing binaries to be improved, at least from a sustainability perspective, by recompiling and/or performing byte-level refactoring to generate new code that better meets or satisfies sustainability goals and policies.

Embodiments of the invention relate, generally, to sustainability operations. Sustainability operations include operations that account for sustainability values. Sustainability operations include analyzing resources such as code, functions, library, infrastructure and the like to ensure that the selection of resources aligns with the sustainability values. Although there are distinctions between code, functions, libraries, binaries, executables, and the like, embodiments of the invention relate to the manner in which these are generated or assembled, which may generally be referred to herein as compiling. Thus, compiling may refer to generating a build manifest, identifying resources for use, generating a binary or executable, or the like. Compiling and/or recompiling, as used herein, may be broader than converting source code into computer executable code. Recompiling and/or compiling may include identifying functions, resources, libraries, executables, infrastructure, or the like. Recompiling also includes evaluating existing compiled code to identify manners in which the code could be improved from a sustainability perspective and then recompiling the code accordingly.

More specifically, embodiments of the invention identify compiled code and then examine ways in which the compiled code can be recompiled in light of sustainability values. This may involve matching compilation methods to asset/resource placement based on sustainability recommendations. The newly compiled code is then orchestrated. In some examples, byte-level snippets may be catalogued to match the underlying systems of execution. This improves matching capabilities when recompiling or byte-code refactoring code for specific sustainability goals. Embodiments of the invention may also track the recompiled code or runtime and the related sustainability metrics.

Sustainability values can be organized in many different ways. Examples of sustainability values are set forth, by way of example and not limitation, in Appendix A, which is incorporated by reference in its entirety.

Sustainability goals can be impacted by code and/or infrastructure. Embodiments of the invention incorporate sustainability goals and policies, using sustainability values, when recompiling code such that the recompiled code is better aligned with the sustainability goals and with awareness regarding the system or infrastructure in which the code is executed.

In one example, a sustainability engine can analyze and match sustainable-specific code, functions and libraries to sustainable values. Once the code, functions, and libraries are identified, the sustainability engine may identify the systems or environments in which the code will be executed. The sustainability engine may then perform, for example, a best-fit match between the identified code, functions, and libraries to the available systems. The code is compiled, and an executable may be delivered. The executable may be tracked, and telemetry readings may be captured for auditing purposes and to improve the performance thereof.

More specifically, embodiments of the invention are able to improve existing binaries through recompiling and/or byte-level refactoring. In one example, a runtime engine is configured to analyze sustainable-specific outcomes of code or applications and compare the sustainable-specific outcomes to the scope of sustainability goals and values. The runtime engine may also be informed of the systems that may execute any runtimes.

When code is available for evaluation, the sustainable-specific target optimized runtime outcomes are evaluated in order to identify new or different code that is available to further optimize or improve the sustainability outcomes. The code may be recompiled using the new or different code.

When code is not available for evaluation, byte level or de-assembled bytes or snippets that can be improved may be identified. The code may be recompiled and executed to confirm the anticipated improvements. Further, the binaries or other executables resulting from any recompilation operations may be tracked. Sustainable telemetry readings can be captured in a historian for auditing and subsequent improvements.

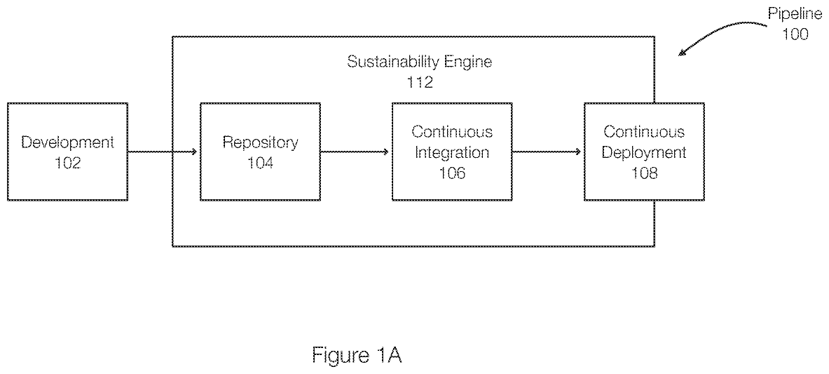

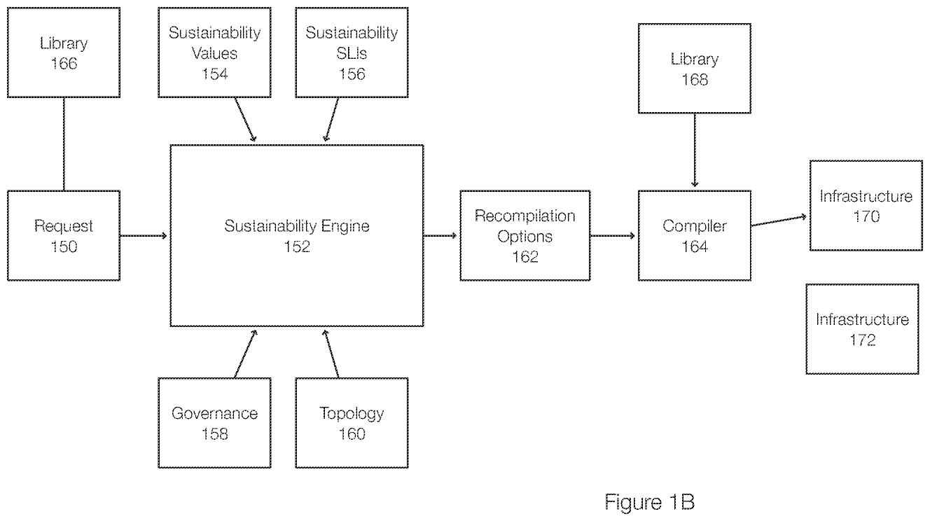

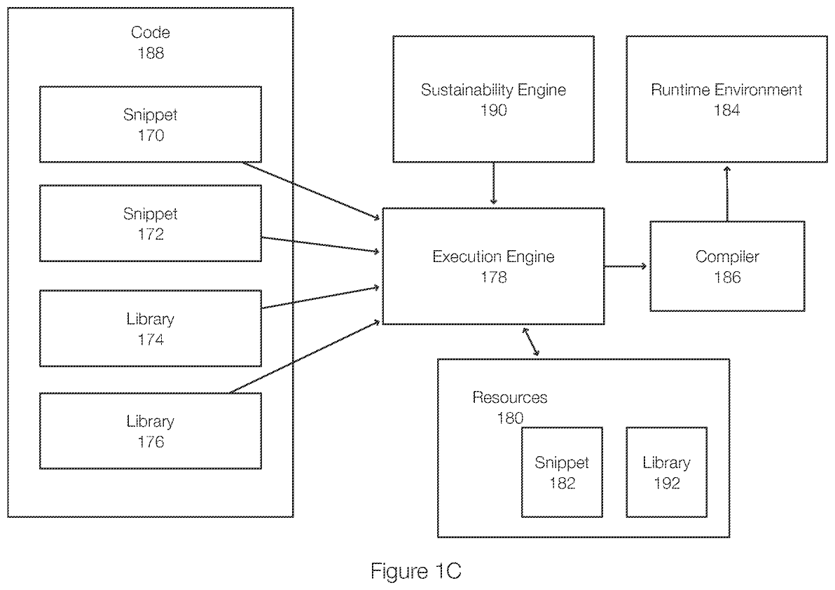

FIG. 1A discloses aspects of a development pipeline. While the pipeline 100 may be represented in different manners, the pipeline 100 is generally configured to move code additions, code changes, or the like to production. In this example, the pipeline 100 generally begins with code development 102. The code generated by a developer may then be stored in a repository 104. However, development 102 may also include infrastructure requests, infrastructure, settings, code updates, or the like.

Inputs to the repository 104 may trigger aspects of continuous integration 106 and continuous deployment 108 (CI/CD). Continuous integration 106 may relate to the process of testing and preparing for the deployment. Continuous deployment 108 may include deploying the code to the intended infrastructure.

The sustainability engine 112 operates at various stages of the pipeline 100 and is not limited to the stages that are illustrated by way of example in FIG. 1A. Although the sustainability engine 112 is not required to operate at any particular stage of the pipeline 100 but may focus on a specific stage or specific stages.

Embodiments of the invention allow code to be compiled or recompiled in a manner that accounts for sustainability goals and values. When a deployment request is received, the code being deployed to determine whether recompiling the code may improve the alignment of the code to sustainability values. Generally, the sustainability engine 112 is configured to ensure that code is compiled or prepared in a manner that accounts for sustainability values.

The sustainability engine 112 may be integrated into the pipeline 100. When code is submitted to the repository 104, the sustainability engine 112 may operate to identify, by way of example, resources such as snippets, functions, infrastructure, and runtime environment, that the code can use or incorporate in order to better align the code with sustainability values. Once these resources are identified, the code can be compiled or recompiled such that the code incorporates these resources and is deployed in a manner that aligns with at least some sustainability values.

In one example, the request may be a deployment request that operates, for example, at the deployment stage of a pipeline. When the request includes compiled code, the sustainability engine may send a list of any executables in the compiled code to an execution engine. The execution engine may be able to compare the compilation settings associated with the list of executables with existing options, placement options and resources, which may be obtained from the sustainability engine, to generate a manifest that allows the code associated with the deployment request to be recompiled.

FIG. 1B discloses aspects of sustainability in code development and deployment. In this example, a request 150 (e.g., a deployment request) is received by a sustainability engine 152. The sustainability engine 152 then operates on the request by seeking information such as sustainability values 154, sustainability service level indicators (SLIs) 156, governance information 158, and topology information 160. This information allows the sustainability engine 152 to match or perform a best fit operation between the request 150, the desired sustainability values, and the resources that are accessible and available. This best fit may be reflected in recompilation options 162.

The recompilation options 162 may identify the functions, libraries, or other resources that should be used instead of the existing functions, libraries, or other resources such that code can be recompiled by the compiler to reflect the sustainability values.

For example, the request 150, which may include executables, may be associated with a library 166. The code may be encapsulated with a library, for example. The sustainability engine 152 may determine that the library 168 is better suited at least in terms of the associated sustainability values. Thus, the recompilation options 162 may identify that the library 168 should be used instead of the library 166. This is reflected in the recompilation options 162. The compiler 164 may recompile the previously compiled code and, in effect, replace the library 166 with the library 168. Further, the recompilation options 162, which are based on sustainability values, may allow the recompiled code to be deployed to an infrastructure 170 rather than the infrastructure 172. In one example, the infrastructure 170 represents or includes a runtime environment that results in improved sustainability outcomes for the code being recompiled. The library 168, in this example, may be a version of the library 166 that is better suited to that runtime environment.

In one example, recompiling code, as disclosed herein, is a process that is intended to change the underlying code without necessarily changing the behavior. The changes may relate to libraries, code snippets, functions, runtime environment, infrastructure, or the like or combination thereof. Code compiled for a virtual Linux environment, for example, may be recompiled to run on a Java virtual machine.

FIG. 1C discloses aspects of recompiling code. FIG. 1C illustrates a list of executables associated with compiled code 188. The executable may include, by way of example, a snippet 170, a snippet 172, a library 174 and a library 176. When code is compiled, the overall compilation may be viewed as an encapsulation or encapsulated package. In one example, the location that code 188 is placed and the runtime environment 184 may be different.

The runtime environment 184, for example, may be a Java virtual machine, a virtualized Linux desktop, a Python-based virtualization, or the like. The runtime environment 184 may have an associated encapsulation method. The encapsulation methods of the runtime environment 184 may specify the libraries, the runtime environment properties, or the like.

If there is a need, for example based on sustainability values, to select a different runtime environment, recompiling the code 188 may include encapsulating the code 188 for the new runtime environment. In this example, the execution engine 178 may receive the code 188 and/or inputs from a sustainability engine 190. More specifically, the sustainability engine 190 may identify, based on the sustainability values, that the request should be executed or deployed to a certain runtime environment. The execution engine uses this information to recompile the code 188. This may include using the snippet 182 to replace the snippet 170 or using a different library 192 rather than the library 174. These options are identified to the execution engine 178, which may generate a manifest that allows the compiler 186 to recompile the code 188 based on the options identified by the execution engine, which are influenced by the sustainability values.

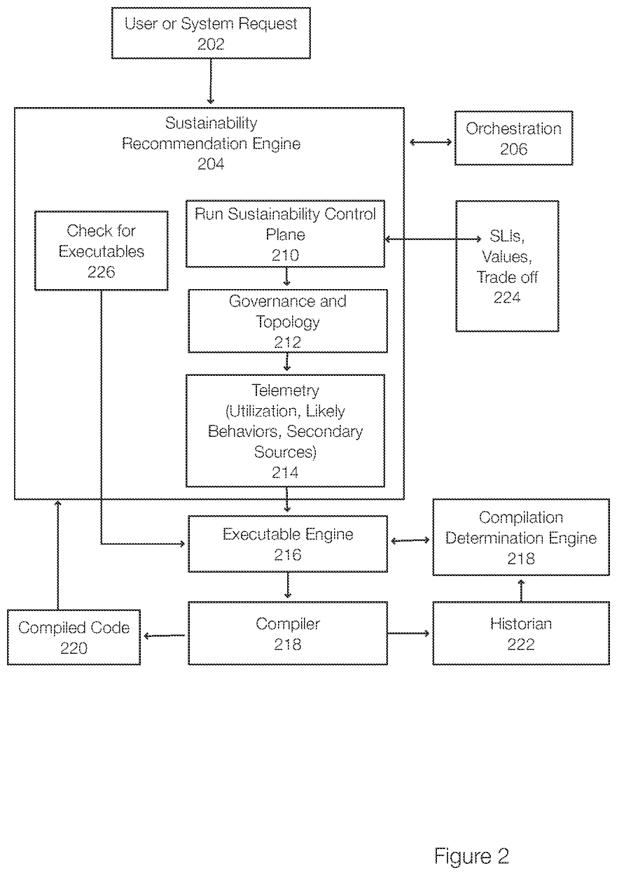

FIG. 2 discloses aspects of sustainability operations. The method 200 may begin when a user or system request, such as a deployment request, is received 202. The request may include a request for resources such as infrastructure resources, the addition of code to a repository, or the like. The request may be to deploy code to a specific runtime environment. The request is received by or intercepted by a sustainability recommendation engine 204.

Once the request is identified by the sustainability recommendation engine 204 (engine 204), the engine 204 begins the process that allows the compiled code, which may be included in the request, to be generated or evaluated in a way that respects or accommodates at least some sustainability values.

The sustainability control plane 210 may access one or more datastores 224 to obtain information related to, by way of example only, sustainability service level indicators (SLIs), sustainability values, and any potential trade-offs.

The SLIs, for example, may have been selected by a service provider, vendor, organization, or individual. SLIs may specify measurable behaviors, goals, or results and may include the locations at which to obtain data as well as the calculations and/or other details.

The sustainability values may be goals that are selected and/or prioritized by a service provider, vendor, organization, or individual. The sustainability values may map to one or more SLIs. For example, power consumption or other values related to sustainability can be measured or calculated.

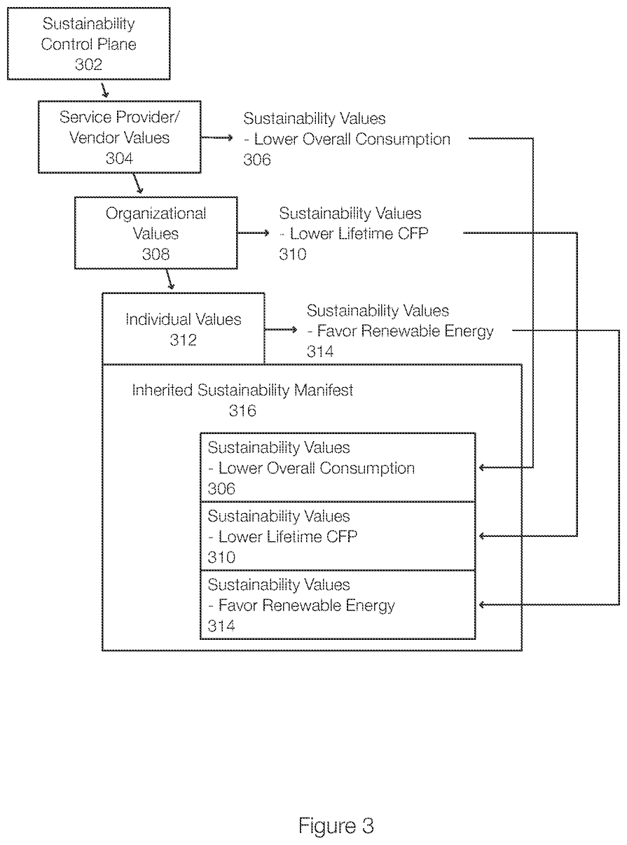

More specifically, the sustainability control plane 210 may compare recommended or inherited sustainability values with sustainability SLIs. FIG. 3 illustrates an example of inherited sustainability values. In the sustainability control plane 304 (an example of the sustainability control plane 210), the service provider or vendor values 304 are associated with organizational values 308, which are associated with individual values 312.

One sustainability value of the service provider/vendor is to lower overall consumption 306. One sustainability value of the organization is to lower the lifetime carbon footprint (CFP) 310. An individual sustainability value in this example is to favor renewable energy 314. The inherited sustainability manifest 316, thus includes to lower overall consumption 306, lower lifetime CFP 310, and to favor renewable energy 314.

During the comparison, it may be necessary to perform a trade-off analysis to ensure that the results satisfy any minimum set of standards. For example, a government may set standards relative to, by way of example, calculations for adverse outcome, system conditions, resource flow, value creation, or the like. See https://www.epa.gov/sites/production/files/2014-10/documents/framework, which is incorporated by reference.

The sustainability value recommendations for the request 202, which may be reflected in the sustainability values illustrated in FIG. 3 for example, can be evaluated in light of SLIs, secondary sources, and any trade-offs to generate an output request that is associated with resulting sustainability values.

Referring back to FIG. 2, next governance and topology are performed 212. More specifically, the system may include a governance control plane and a topology plane. The governance control plane may evaluate the resources that are accessible or available to the request or the user. The topology plane may identify what exists in light of available resources.

Finally, telemetry 214 is performed. Telemetry may evaluate the utilization, likely behaviors, and secondary sources. The output of telemetry 214, from the input that came through the sustainability control plane 210 and governance and topology 212, may include a list of resources or assets that could be used for the request. More specifically, the output of the sustainability recommendation engine 204 is a set of recommended resources that may be used to meet the sustainability goals of a user or organization. The recommended assets or resources may include code snippets, functions, libraries, infrastructure, runtime environments, or the like or combinations thereof.

This set of resources is provided to an execution engine 216 that consults a complication determination service 218. The sustainability recommendation engine 204 may also check the request for executables 226. Executables, when present, are provided to the execution engine 216.

The compilation determination engine 218 may filter the known compiler options (including libraries, compilation settings, runtime environments, functions etc.) and compare these options against the set or recommended resources output from the sustainability recommendation engine 204 and or the resources identified by or included in the list of executables associated with the request 202. This information is then matched against existing libraries, services, algorithms, or other compilation variables. The result is provided back to the execution engine 216 as compilation settings, which may generate an assembly manifest (e.g., a build pack, or other form). The compiler 218 receives the assembly manifest and performs the compilation or recompilation. More specifically, the compiler 218 may recompile the executables in the request 202 based on the assembly manifest. This may be a new compilation or may simply include replacing portions of the executables as needed. For example, this may include replacing libraries, code snippets, or the like. The recompiled code 220 is returned to the sustainability recommendation engine 204 and may be orchestrated 206 (e.g., deployed). The recompiled code may simply be deployed.

The historian 222 may store information related to the calculations, decisions, inputs, and outputs associated with recompiling the code, which may be used for audits, future calculations and analytics, or the like.

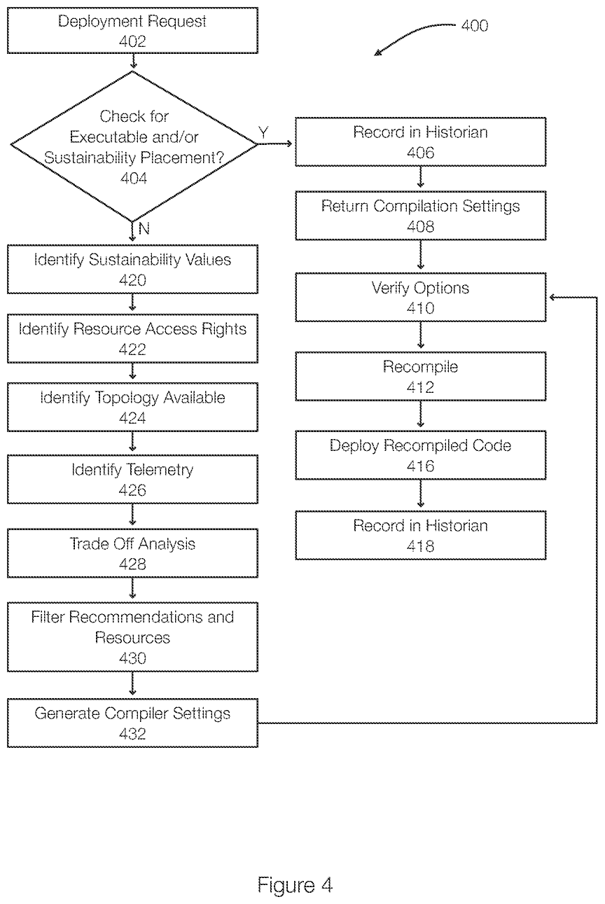

FIG. 4 discloses aspects of sustainably recompiling code. In the method 400, a deployment request 402 may be received. This may occur in the context of a pipeline and the request 402 may be received by a sustainability engine operating in or in conjunction with the pipeline. When the request 402 is received, the historian is checked 404 to see if the request includes known executables and/or whether sustainability placement has been performed for this type of request. If so (yes at 404), this suggests that the response to the request 402 has already been performed for this type. Thus, the new compilation request is recorded 406 in the historian and the compilation settings are returned 408 or identified.

Once the compilation settings are identified, the resource availability is verified 410. If resources are available, recompilation is performed 412. The recompilation 412 may be based on a manifest, which reflects the options or resources (libraries, snippets, etc.) to include in the recompilation. The manifest may be reviewed 414, if desired, by a user or automatically. The recompiled code is then deployed 416 to the resources and the actions are recorded 418 in the historian. The recompiled code aligns with the sustainability values of the user.

If recompilation recommendations do not exist (N at 404) for the deployment request 402, sustainability values for the request are identified 420. The sustainability values may relate, by way of example and not limitation, to power consumption, carbon footprint, alternative energy, placement based on energy source, power consumption through up-to-date product refresh, predicted carbon footprint, manufacturing footprint, recycled material use, end of life impacts, or the like. These sustainability values may include inherited sustainability values as illustrated in FIG. 3.

Next, resource access rights are evaluated 422 and the topology is also identified 424. The access rights 422 allow the sustainability engine to identify what the user or requestor has access to and the topology identification 424 allows the sustainability engine to compare this with the resources that are actually available. This may result, by way of example, in the identification of a different runtime environment from the deployment request that is different from the original runtime environment.

Telemetry may be performed 426. Telemetry may evaluate the probable behavior and may identify which resources can meet the expected behavior. In this example, the metrics for the SLIs may be captured in order to evaluate the telemetry in the context of the sustainability values. This may include evaluating the new runtime environment and its likely behavior.

A trade-off analysis 428 may be performed. In one example, the options may be scored and ranked. Next, using available resources and likely needs, which may be determined from the sustainability values 420, the resource access rights 422, the topology 424, and the telemetry 426, the recommendations, which includes resources for the request, are filtered 430. Filtering allows the resource recommendations most aligned with the request and the inherited sustainability values to be identified. Once the resource recommendations are complete, the compiler settings are generated 432.

Resource availability is verified 410 and the code in the deployment request is recompiled. A review may be performed 414. After the review, the recompiled code is deployed 416 and the actions are recorded 418 in the historian.

Resource directed decision making can support the sustainability goals of an organization. Embodiments of the invention determine compilation options that map to the recommended resource utilization for an organization. For example, this may take the form of library matching based on resource utilization. In other example, specific code snippets, libraries, or the like that are optimized to use a specific resource in a way that is aligned with an organization's sustainability goals can be selected and included in the build manifest and used in recompiling the code.

The historian and/or feedback loops can measure the utilization of the resource compilations and compilation options, which allows the capabilities of the systems that are used to be inferred. This further allows system behaviors to be confirmed or allows actual system behaviors to be realigned with sustainability priorities and/or goads.

For example, a sustainability recommendation engine may receive a request to deploy an application. The sustainability recommendation engine may gather all compiled code snippets, libraries, etc., associated with the deployment request into a list of executables and send the list of executables, with pointers, to the execution engine. The historian may be checked to determine if inherited sustainability values are present for this request type for this user. If so, a recommendation for a recent matching type, if present, may be used. This allows the request to be sent directly to the execution engine.

If the request is a new request type, a new resource, type, a new executable set, or a new user, the sustainability values are determined for the requesting user. In this example, the inherited sustainability values may identify a vendor sustainability value of a desire to pursue low power consumption and an organization sustainability value related to a lifetime carbon footprint for the consumption of resources. Thus, if an organization buys new hardware, the organization is responsible for reporting on the full product carbon footprint from manufacturing to decommissioning. The inherited sustainability values may also include an individual sustainability value of using recycled resources when possible.

In one example, these individual sustainability values may be weighted. Further, in the event of a conflict, the more specific value may be given priority.

Next, the governance control plane determines access rights. This is matched against topology available to the requesting user.

From the resources that are available based on the governance and topology evaluations, a list of recommended options may be identified. The execution engine may compare the recommended options to possible compilation options. The execution engine then takes the existing code and sends it to the correct compiler to recompile the code at the byte level to execute in the appropriate operating system or runtime environment.

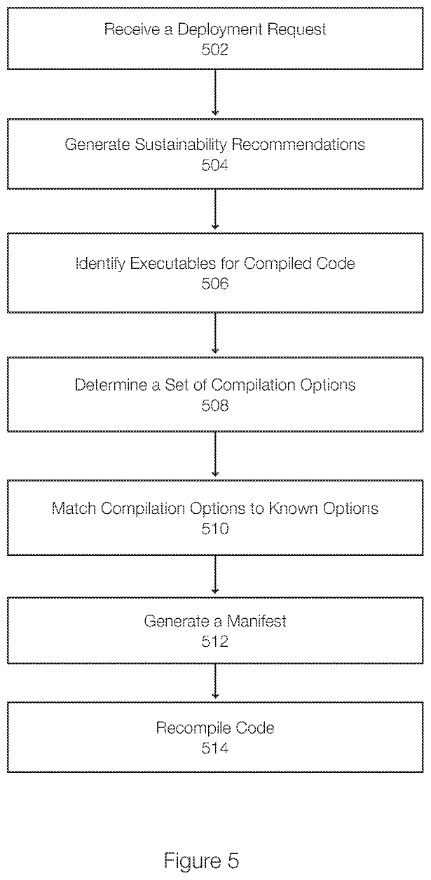

FIG. 5 discloses aspects of sustainability options when recompiling code. In FIG. 5, a deployment request is received 502. In response to the deployment request, sustainability recommendations 504 are determined. Sustainability recommendations may be based on sustainability values, sustainability SLIs, trade-offs, or the like. In addition to identifying the sustainability recommendations, the executables for the compiled code are identified 506.

Next, a set of compilation options are determined 508. This may include using a compilation determination engine to align the executables with the sustainability options and/or to identify other executables that are more aligned with the sustainability values. Next, the compilation options are matched 510 to the known options.

This allows the execution engine to generate 512 a manifest that reflect the sustainability values in the context of available resources and that allow the code to be recompiled using executables that have been identified as being more aligned with the sustainability values. The code may be recompiled 514 and deployed.

In general, embodiments of the invention may be implemented in connection with systems, software, and components, that individually and/or collectively implement, and/or cause the implementation of, sustainability operations. Sustainability operations including sustainability value analysis operations, compilation operations, and the like.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, virtual machines (VM), or containers.

Particularly, devices in the operating environment may take the form of software, physical machines, VMs, containers or any combination of these, though no particular device implementation or configuration is required for any embodiment.

It is noted that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

Following are some further example embodiments of the invention. These are presented only by way of example and are not intended to limit the scope of the invention in any way.

Embodiment 1. A method, comprising: A method, comprising: receiving a deployment request at a sustainability engine that includes compiled code that includes executables, generating sustainability recommendations for the compilation request based on sustainability values and sustainability service level indicators, identifying potential resources for the compilation request, defining a set of compilation options based on the sustainability recommendations, the potential resources, and the executables, matching the set of compilation options to a known set of compilation options to select specific compilation settings that at least partially align with the sustainability recommendations, generating a manifest that includes the specific compilation options, and recompiling the compiled code using the specific compilation settings.

Embodiment 2. The method of embodiment 1, further wherein the sustainability values include inherited sustainability values including organizational sustainability values and individual sustainability values.

Embodiment 3. The method of embodiment 1 and/or 2, further comprising identifying resources accessible to the deployment request.

Embodiment 4. The method of embodiment 1, 2, and/or 3, further comprising determining which of the resources are available.

Embodiment 5. The method of embodiment 1, 2, 3, and/or 4, further comprising determining a telemetry of the resources.

Embodiment 6. The method of embodiment 1, 2, 3, 4, and/or 5, further comprising generating the set of compilation operations based on the telemetry.

Embodiment 7. The method of embodiment 1, 2, 3, 4, 5, and/or 6, wherein the request comprises code and/or an infrastructure request and/or a runtime environment.

Embodiment 8. The method of embodiment 1, 2, 3, 4, 5, 6, and/or 7, wherein the manifest comprises a best fit between the sustainability values and the resources identified in the manifest.

Embodiment 9. The method of embodiment 1, 2, 3, 4, 5, 6, 7, and/or 8, further comprising recompiling the code based on a runtime environment identified in the sustainability recommendations, wherein recompiling the code includes reencapsulating the code with libraries and code snippets associated with the runtime environment.

Embodiment 10. The method of embodiment 1, 2, 3, 4, 5, 6, 7, 8, and/or 9, further comprising recording actions, decisions and sustainability values associated with recompiling the code in a historian.

Embodiment 11. A method comprising: receiving a deployment request that includes code, the compiled code associated with a list of executables and a runtime environment, identifying a new runtime environment for the code based on sustainability values, and recompiling the code as recompiled code based on the new runtime environment.

Embodiment 12. The method of embodiment 11, further comprising: identifying, using a compilation determination engine, libraries and/or code snippets to include in the recompiled code based on the new runtime environment and the sustainability values, identifying sustainability values for the request received at a sustainability engine, determining resource access rights based on the sustainability values, identifying a topology from the resource access rights, determining a telemetry of the topology, generating compiler settings, based on the sustainability values, the topology, and the telemetry, that includes a set of recommended resources to at least partially meet the sustainability values, matching the set of recommended resources against known resources to generate a final set of resources for the request, and generating the recompiled code based on the final set of resources.

Embodiment 13. A method for performing any of the operations, methods, or processes, or any portion of any of these, or any combination thereof disclosed herein.

Embodiment 14. A non-transitory storage medium having stored therein instructions that are executable by one or more hardware processors to perform operations comprising the operations of any one or more of embodiments 1-13.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

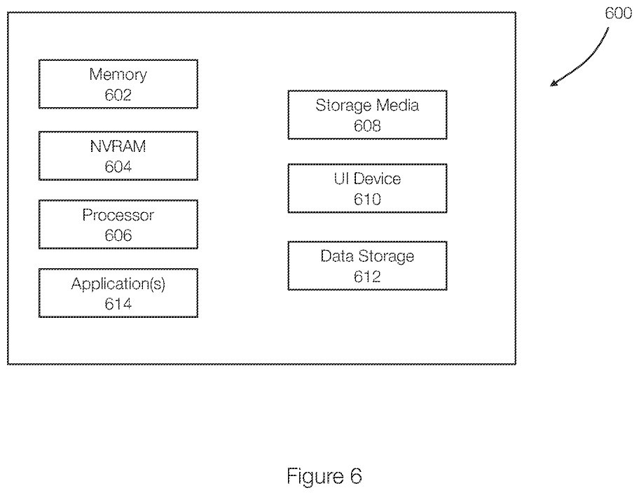

With reference briefly now to FIG. 6, any one or more of the entities disclosed, or implied, by the Figures and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 6.

In the example of FIG. 6, the physical computing device 600 includes a memory 602 which may include one, some, or all, of random-access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory components 604 of the physical computing device 600 may take the form of solid-state device (SSD) storage. As well, one or more applications 614 may be provided that comprise instructions executable by one or more hardware processors 606 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

what is claimed is:

1. A method, comprising:
receiving a deployment request at a sustainability engine that includes compiled code that includes executables;
generating sustainability recommendations for the compilation request based on sustainability values and sustainability service level indicators;
identifying potential resources for the compilation request;
defining a set of compilation options based on the sustainability recommendations, the potential resources, and the executables;
matching the set of compilation options to a known set of compilation options to select specific compilation settings that at least partially align with the sustainability recommendations; and
recompiling the compiled code using the specific compilation settings.

2. The method of claim 1, further wherein the sustainability values include inherited sustainability values including organizational sustainability values and individual sustainability values.

3. The method of claim 1, further comprising identifying resources accessible to the deployment request.

4. The method of claim 3, further comprising determining which of the resources are available.

5. The method of claim 4, further comprising determining a telemetry of the resources.

6. The method of claim 5, further comprising generating the set of compilation operations based on the telemetry.

7. The method of claim 1, wherein the request comprises code and/or an infrastructure request and/or a runtime environment.

8. The method of claim 1, further comprising generating a manifest that includes the specific compilation options, wherein the manifest comprises a best fit between the sustainability values and the resources identified in the manifest.

9. The method of claim 1, further comprising recompiling the code based on a runtime environment identified in the sustainability recommendations, wherein recompiling the code includes reencapsulating the code with libraries and code snippets associated with the runtime environment.

10. The method of claim 1, further comprising recording actions, decisions and sustainability values associated with recompiling the code in a historian.

11. A non-transitory storage medium having stored therein instructions that are executable by one or more hardware processors to perform operations comprising:
receiving a deployment request at a sustainability engine that includes compiled code that includes executables;
generating sustainability recommendations for the compilation request based on sustainability values and sustainability service level indicators;
identifying potential resources for the compilation request;
defining a set of compilation options based on the sustainability recommendations, the potential resources, and the executables;
matching the set of compilation options to a known set of compilation options to select specific compilation settings that at least partially align with the sustainability recommendations; and
recompiling the compiled code using the specific compilation settings.

12. The non-transitory storage medium of claim 11, wherein the sustainability values include inherited sustainability values including organizational sustainability values and individual sustainability values, further comprising identifying resources accessible to the deployment request and determining which of the resources are available.

13. The non-transitory storage medium of claim 12, further comprising determining a telemetry of the resources.

14. The non-transitory storage medium of claim 13, further comprising generating the set of compilation operations based on the telemetry.

15. The non-transitory storage medium of claim 11, wherein the request comprises code and/or an infrastructure request and/or a runtime environment.

16. The non-transitory storage medium of claim 11, further comprising generating a manifest that includes the specific compilation options, wherein the manifest comprises a best fit between the sustainability values and the resources identified in the manifest.

17. The non-transitory storage medium of claim 11, further comprising recompiling the code based on a runtime environment identified in the sustainability recommendations, wherein recompiling the code includes reencapsulating the code with libraries and code snippets associated with the runtime environment.

18. The non-transitory storage medium of claim 11, further comprising recording actions further comprising recording actions, decisions and sustainability values associated with recompiling the code in a historian.

19. A method comprising:
receiving a deployment request that includes code, the compiled code associated with a list of executables and a runtime environment;
identifying a new runtime environment for the code based on sustainability values; and
recompiling the code as recompiled code based on the new runtime environment.

20. The method of claim 19, further comprising:
identifying, using a compilation determination engine, libraries and/or code snippets to include in the recompiled code based on the new runtime environment and the sustainability values;
identifying sustainability values for the request received at a sustainability engine;
determining resource access rights based on the sustainability values;
identifying a topology from the resource access rights;
determining a telemetry of the topology;
generating compiler settings, based on the sustainability values, the topology, and the telemetry, that includes a set of recommended resources to at least partially meet the sustainability values;
matching the set of recommended resources against known resources to generate a final set of resources for the request; and
generating the recompiled code based on the final set of resources.
